(19) United States
(12) Patent Application Publication
(10) Pub. No.: US 2019/0003452 A1
(43) Pub. Date: Jan. 3, 2019

(54) Vertical Axis Wind Turbine Assembly

(71) Applicant: RTB Solutions, Inc., Lakewood, CO (US)

(72) Inventor: Richard T. Barcia, JR., Lakewood, CO (US)

(21) Appl. No.: 16/024,720

(22) Filed: Jun. 29, 2018

Related U.S. Application Data
(60) Provisional application No. 62/527,433, filed on Jun. 30, 2017.

(51) Int. Cl. F03D 3/00; F03D 3/04; F03D 3/06; F03D 9/25

(52) U.S. Cl. CPC F03D 3/005; F03D 3/0427; F03D 3/064; F05B 2240/91; F05B 2240/211; F05B 2220/7068; F05B 2240/50; F03D 9/25

(57) ABSTRACT

A vertical axis wind turbine assembly is described. Embodiments of the vertical axis wind turbine assembly can include a main support structure, a turbine blade sub-assembly, a wind directional panel sub-assembly, and a generator. Wind directional panels can be spaced radially about a plurality of turbine blades. Of note, adjacent wind directional panels can form a plurality of wind tunnels directing wind towards the plurality of turbine blades. The turbine blades can be coupled to an axle that is also coupled to the generator.

### CROSS-REFERENCE TO RELATED APPLICATION

This application claims the benefit of U.S. Provisional Application No. 62/527,433, filed Jun. 30, 2017.

### BACKGROUND

Wind turbines are devices that convert wind's kinetic energy into electrical energy. Betz's law indicates the maximum power that can be extracted from the wind, independent of the design of a wind turbine in open flow. According to Betz's law, no turbine can capture more than 16/27 (59.3%) of the kinetic energy in wind. The factor 16/27 (0.593) is known as Betz's coefficient.

Many factors go into decreasing the efficiency of capturing close to 100% of the Betz limit. Currently, practical utility-scale wind turbines achieve at peak 75% to 80% of the Betz limit.

A wind turbine designed to more efficiently capture wind energy closer to the Betz limit is needed.

### BRIEF DESCRIPTION OF THE DRAWINGS

FIG. 1A is a side view of a vertical axis wind turbine assembly according to one embodiment of the present invention.

FIG. 1B is a side view of a vertical axis wind turbine assembly according to one embodiment of the present invention.

FIG. 2A is a top view of a turbine blade sub-assembly according to one embodiment of the present invention.

FIG. 2B is side view of a turbine blade sub-assembly and a main support structure according to one embodiment of the present invention.

FIG. 2C is a top view of a turbine blade according to one embodiment of the present invention.

FIG. 2D is a side view of a turbine blade and blade support rings according to one embodiment of the present invention.

FIG. 3A is a top view of a wind directional panel sub-assembly according to one embodiment of the present invention.

FIG. 3B is a top view of a panel support structure according to one embodiment of the present invention.

FIG. 4A is a top view of a turbine blade sub-assembly and a wind directional panel sub-assembly according to one embodiment of the present invention.

FIG. 4B is a top view of a vertical axis wind turbine assembly showing a power curve according to one embodiment of the present invention.

FIG. 5 is a top view of a vertical axis wind turbine assembly including example measurements according to one embodiment of the present invention.

### DETAILED DESCRIPTION

Embodiments of the present invention include a vertical axis wind turbine (VAWT) assembly. The VAWT assembly can include, but is not limited to, a main support structure, a wind directional panel sub-assembly, a turbine blade sub-assembly, and a generator. The wind directional panel sub-assembly can include a plurality of wind directional panels coupled to a panel support structure, providing structural integrity to the wind directional panels. As can be appreciated, by allowing the wind directional panels to be coupled to the panel support structure, a lighter material may be implemented for the wind directional panels, thus reducing an overall weight of the VAWT assembly. The turbine blade sub-assembly can include a plurality of turbine blades coupled to a blade support structure. The panel support structure and the blade support structure can be coupled to, or integrated with, the main support structure.

Embodiments of the present invention can include wind directional panels fixed in place to give the illusion of a solid surface such that birds will avoid flying into the VAWT assembly. The VAWT assembly can be configured to minimize sound and produce about 50-55 decibels of sound when operating. Moving components of the VAWT assembly can include a pair of flange bearings, an axle, a thrust bearing, a generator, and a turbine blade sub-assembly. Typically, the generator can be located on the ground reducing vibration to components of the VAWT assembly. Of note, the VAWT assembly can be scaled in size to produce 5 kW up to 5 MW of energy.

In one embodiment, the wind directional panels can be spaced radially about the plurality of turbine blades. Of note, adjacent wind directional panels can form a plurality of wind tunnels directing wind towards the plurality of turbine blades. The plurality of wind directional panels can be coupled to an outer support ring of the panel support structure that is in turn supported by a plurality of support members of the main support structure. By implementing the outer support ring coupled to support members, the wind directional panels do not have to provide structural support to the VAWT assembly, thus reducing an overall weight of the VAWT assembly. The support members can typically be equally spaced about the outer ring and can be placed in cement footings. The wind directional panels can further be coupled to an inner support ring of the panel support structure. Typically, the wind directional panels can be angled approximately 68 degrees from parallel with a radial line of a circle formed by the VAWT assembly. The wind directional panels can be angled between 60.1 degrees to 80 degrees.

The blade support structure can include a plurality of braces radially spaced from a center of the VAWT assembly and a support ring coupled to the plurality of braces. The plurality of turbine blades can be coupled to the blade support ring. Typically, the turbine blades can be evenly spaced around the blade support ring. In one embodiment, there can be an upper blade support ring and a lower blade support ring. Of note, in some embodiments there may either be the upper blade support ring or the lower blade support ring coupled to the plurality of turbine blades. In one embodiment, the plurality of turbine blades can be coupled to the blade support ring at an angle of approximately 6 degrees from parallel with a radial line of the circle formed by the VAWT assembly. The plurality of turbine blades can be angled between 2 to 14.9 degrees.

In one embodiment, the panel support structure can include an upper outer support ring, a lower outer support ring, an upper inner support ring, and a lower inner support ring. The outer support rings can be coupled to the plurality of support members forming the main support structure. An upper portion of an exterior end of the wind directional panels can be coupled to the upper outer support ring and a lower portion of the exterior end of the wind directional panels can be coupled to the lower outer support ring. An upper portion of an interior end of the wind directional panels can be coupled to the upper inner support ring and a lower portion of the interior end of the wind directional panels can be coupled to the lower inner support ring. Stated alternatively, the plurality of wind directional panels can be coupled to outer support rings proximate a top and a bottom of a first side of the panels and can be coupled to inner support rings proximate a top and a bottom of a second side of the panels.

In one embodiment, the plurality of wind directional panels and the plurality of turbine blades can both be manufactured from 14-gauge flat sheet steel. In one example, the plurality of wind directional panels can each be a 3.5′ by 11′ flat sheet of 14-gauge steel.

In one embodiment, a turbine blade can be defined by a central portion being approximately 3″ long, a first protrusion extending away from a first end of the central portion and being approximately 3″ long, and a second protrusion extending away from a second end of the central portion and being approximately 2″ long. An angle between the first protrusion and the central portion can be approximately 123 degrees and an angle between the second protrusion and the central portion can be approximately 115 degrees. A width of the turbine blade can be defined by the distance from an end of the central portion to an end of the first protrusion, which can be approximately 5 and ⅛ inches.

In one example, the plurality of turbine blades can each be manufactured from 14-gauge flat sheets of steel formed into the previously described shape. For instance, a first sheet can be a 3″ by 10′ 14-gauge flat sheet, a second sheet can be a 3″ by 10′ 14-gauge flat sheet, and a third sheet can be a 2″ by 10′ 14-gauge flat sheet. In another example, the plurality of turbine blades can each be formed from a single sheet of steel. For instance, an approximately 8″ by 10′ sheet of 14-gauge steel can be formed into each of the turbine blades.

Of note, the plurality of turbine blades may include two or more sets of turbine blades having a height of 5 feet for two sets of turbine blades and a height of 3 feet 4 inches for three sets of turbine blades. For instance, the first set of blades can be set in-line and on top of the second set of blades. As can be appreciated, more than three sets of turbine blades are contemplated.

In one embodiment, a power curve formed by the plurality of wind directional panels of the VAWT assembly can include 12 turbine blades in the power curve. With the wind directional panels angled at approximately 68 degrees, backpressure can be reduced from wind that interfaces with the turbine blades. As can be appreciated, when wind blows from any direction the wind can blow to a left side, a center, and a right side of the turbine blades. By having the wind directional panels angled at approximately 68 degrees, 12 turbine blades can be included in the power curve which generates power. Further, by reducing backpressure, the efficiency of the VAWT assembly may increase.

Typically, a diameter of the outer panel support ring can be approximately 27% larger than a diameter of the blade support ring. Of note, a gap (or distance) between the interior panel support ring of the plurality of wind directional panels and the plurality of turbine blades can be approximately 1 and ⅜ inches. An angle between a wind directional panel and a radial line of a center of the VAWT assembly can be approximately 68 degrees. Each of the wind directional panels can be approximately 3.5 feet wide.

In one example embodiment, the blade support ring can have a diameter of approximately 16 feet. The outer panel support ring of the wind directional panels can have a diameter of approximately 20 feet 4 and 5/16 inches. The inner panel support ring of the wind directional panels can have a diameter of approximately 16 feet 8 and 1/16 inches.

One embodiment of the VAWT assembly can have an overall height of approximately 31 feet 1 inches from the ground to a top of the VAWT assembly. The VAWT assembly can include a plurality of cement footings being approximately 7 feet 11 inches long. Of note, the measurements provided are but one example and are not meant to be limiting.

In one embodiment, the blade support structure can include two or more sets of the plurality of blade braces. Typically, each set of blade braces can be evenly spaced along a height of the blade support structure. The blade braces can extend radially from a center of the VAWT assembly and can be operatively coupled to an axle. As can be appreciated, when the turbine blades are pushed by wind, the turbine blades can rotate the axle to convert mechanical energy into electrical energy via the generator.

Of note, the plurality of turbine blades can be configured to rotate under the power or wind. The wind directional panels can direct wind into a power curve whereby the directed wind can push the plurality of turbine blades in a circle rotating an axle. The plurality of blade braces can be implemented to provide structural support to the plurality of turbine blades.

In an example embodiment, the VAWT assembly can include 20 wind directional panels, 48 turbine blades, a generator, and a support structure having an overall height of approximately 31 feet 1 inch. The 20 wind directional panels can be approximately 11 feet tall by 3.5 feet wide. The 20 wind directional panels can be coupled to an outer ring of the support structure. The outer ring can have a substantially circular shape. The wind directional panels can be coupled to the outer ring at approximately 68 degrees to give a directional line of site to an inside of the turbine blades. The 20 wind directional panels can be evenly spaced around the 48 turbine blades. An inside end of each of the wind directional panels can be covered by an outer end of another wind directional panel by approximately 7 to 12 inches. The 48 turbine blades can each be approximately 5 and ⅛ inches wide by 10 feet long. The 48 turbine blades can be angled approximately 6 degrees from center of the VAWT assembly to match the directional line of site of the wind directional panels. Each of the 48 turbine blades can be spaced approximately 12.057″ from one another. A gap between the wind directional panels and the turbine blades can be approximately 1 and ⅜ inches.

U.S. non-provisional application Ser. No. 14/285,906, filed on May 23, 2014, titled “WIND TURBINE DEVICE WITH DIVERTER PANELS AND RELATED SYSTEMS AND METHODS” is hereby incorporated in its entirety by reference.

### Terminology

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning either or both.

References in the specification to “one embodiment”, “an embodiment”, “another embodiment, “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation.

The term “couple” or “coupled” as used in this specification and appended claims refers to an indirect or direct physical connection between the identified elements, components, or objects. Often the manner of the coupling will be related specifically to the manner in which the two coupled elements interact.

The term “directly coupled” or “coupled directly,” as used in this specification and appended claims, refers to a physical connection between identified elements, components, or objects, in which no other element, component, or object resides between those identified as being directly coupled.

The term “approximately,” as used in this specification and appended claims, refers to plus or minus 10% of the value given.

The term “about,” as used in this specification and appended claims, refers to plus or minus 20% of the value given.

The terms “generally” and “substantially,” as used in this specification and appended claims, mean mostly, or for the most part.

Directional and/or relationary terms such as, but not limited to, left, right, nadir, apex, top, bottom, vertical, horizontal, back, front and lateral are relative to each other and are dependent on the specific orientation of a applicable element or article, and are used accordingly to aid in the description of the various embodiments and are not necessarily intended to be construed as limiting.

### An Embodiment of a Vertical Axis Wind Turbine Assembly

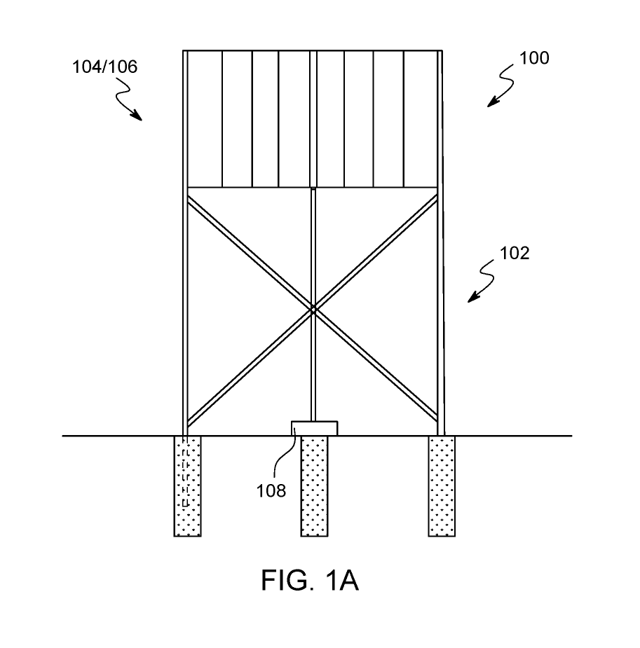

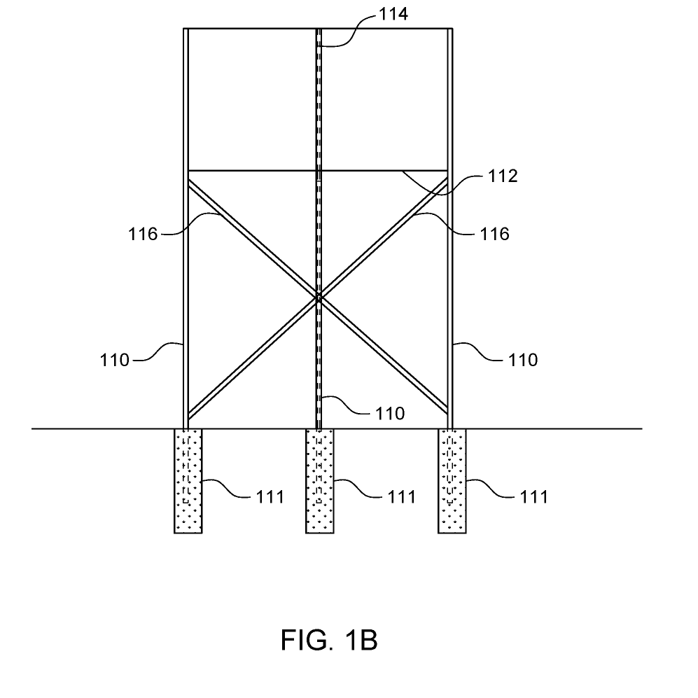

Referring generally to FIGS. 1A-1B, detailed diagrams of an embodiment 100 of a vertical axis wind turbine assembly are illustrated. The vertical axis wind turbine (VAWT) assembly 100 can be implemented to convert wind into storable energy. The VAWT assembly 100 can implement a plurality of turbine blades configured to rotate about a central axis and can include panels configured to direct wind towards the turbine blades. Typically, the VAWT assembly 100 can have a substantially circular cross-section allowing for 360-degree capture of wind.

Referring to FIG. 1A, a side view of the VAWT assembly 100 is illustrated. As shown, the VAWT assembly 100 can include, but is not limited to, a main support structure 102, a turbine blade sub-assembly 104, a wind directional panel sub-assembly 106, and a generator 108. In a typical implementation, the turbine blade sub-assembly 104 can be coupled to or integrated with the main support structure 102 and the wind directional panel sub-assembly 106 can be coupled to or integrated with the main support structure 102.

Referring to FIG. 1B, a side view of the main support structure 102 is illustrated. As shown, the main support structure 102 can include, but is not limited to, a plurality of support members 110, a platform 112, an axle 114 (shown in a dotted line), and one or more cross-members 116. Typically, the support members 110 can be implemented as posts. In one embodiment, the plurality of support members 110 can be metal rods implemented as posts. The plurality of support members 110 can be set in the ground such that the support members 110 are firmly set in place. For instance, the support members 110 can be embedded in cement footings 111. Although cement footings are shown, other means of securing the support members 110 are contemplated. Of note, embodiments are contemplated where the support members 110 are shorter to place the VAWT assembly 100 closer to the ground.

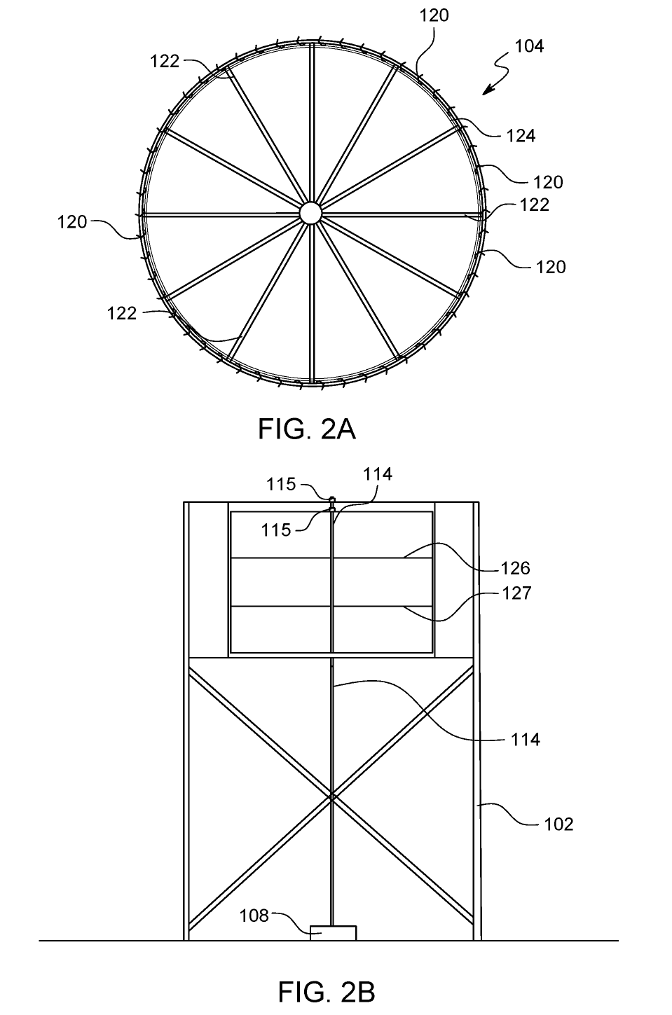

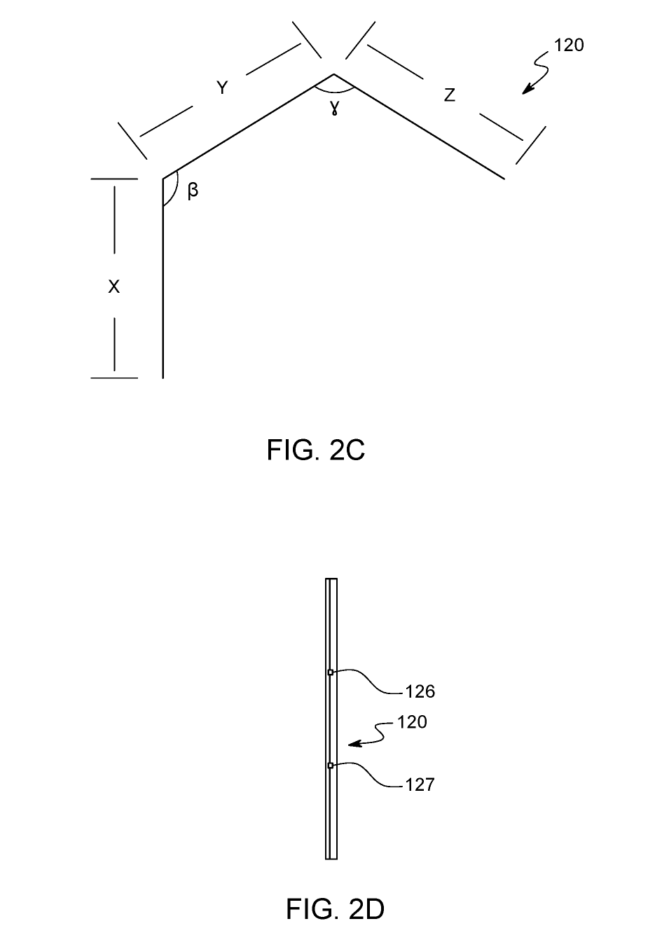

Referring to FIG. 2A, a top view of the turbine blade sub-assembly 104 is illustrated. As shown, the turbine blade sub-assembly 104 can include, but is not limited to, a plurality of turbine blades 120, a plurality of blade braces 122, and a support ring 124. The plurality of blade braces 122 can be coupled to the support ring 124 and can form a blade support structure. Typically, each of the plurality of turbine blades 120 can be coupled to the support ring 124. As shown, the turbine blades 120 can be evenly spaced around the blade support ring 124. In one embodiment, there can be an upper blade support ring and a lower blade support ring. Of note, in some embodiments there may either be the upper blade support ring or the lower blade support ring coupled to the plurality of turbine blades. In one embodiment, the plurality of turbine blades 120 can be coupled to the blade support ring 124 at an angle of approximately 6 degrees from parallel with a radial line of a circle formed by the VAWT assembly 100. Typically, the plurality of turbine blades 120 can be angled between 2 to 14.9 degrees.

Referring to FIG. 2B, a side view of the blade support structure coupled to the main support structure 102 is illustrated. As shown, the blade support structure can include an upper support ring 126 and a lower support ring 127. As can be appreciated, each of the support rings 126, 127 can include a plurality of blade braces 122 (not shown). The support rings 126, 127 can be coupled to the axle 114 such that when wind pushes the plurality of turbine blades 120, the axle 114 is rotated. As shown in FIG. 2B, the axle 114 can be coupled to a plurality of bearings 115. In one embodiment, the plurality of bearings 115 can include two or more different types of bearings. For example, the plurality of bearings 115 can include two flange bearings and a single thrust bearing.

Referring to FIG. 2C, a top view of one of the plurality of turbine blades 120 is illustrated. In one embodiment, a central portion “Y” can be approximately 3″ wide, a first protrusion “X” extending away from a first end of the central portion “Y” can be approximately 3″ wide, and a second protrusion “Z” extending away from a second end of the central portion “Y” can be approximately 2″ wide. As shown, an angle β formed between the first protrusion “X” and the central portion “Y” can be approximately 123 degrees. An angle γ formed between the second protrusion “Z” and the central portion “Y” can be approximately 115 degrees. A width of the turbine blade 120 can be defined by the distance from an end of the central portion “Y” proximate the second protrusion “Z” to an end of the first protrusion “X”, which can be approximately 5 and ⅛ inches.

As previously mentioned, the plurality of turbine blades 120 can be coupled to the blade support ring 124 at an angle of approximately 6 degrees from parallel with a radial line of a circle formed by the VAWT assembly 100. Generally, the central portion “Y” of the turbine blade can be angled approximately 6 degrees from parallel with a radial line of the circle formed by the VAWT assembly 100.

Referring to FIG. 2D, a side view of one of the plurality of turbine blades 120 is illustrated. As shown, the upper support ring 126 can be coupled to an upper portion of the turbine blade 120 and the lower support ring 127 can be coupled to a lower portion of the turbine blade 120. Of note, the support rings 126, 127 can be moved along a length of the turbine blade 120 without exceeding a scope of the present invention.

In one example, the plurality of turbine blades 120 can each be manufactured from 14-gauge flat sheets of steel formed into the shape shown in FIG. 2C. In another embodiment, the plurality of turbine blades 120 can each be formed from a single sheet of steel. For instance, a first sheet can be a 3″ by 10′ 14-gauge flat sheet, a second sheet can be a 3″ by 10′ 14-gauge flat sheet, and a third sheet can be a 2″ by 10′ 14-gauge flat sheet. In another instance, an approximately 8″ by 10′ sheet of 14-gauge steel can be formed into each of the turbine blades.

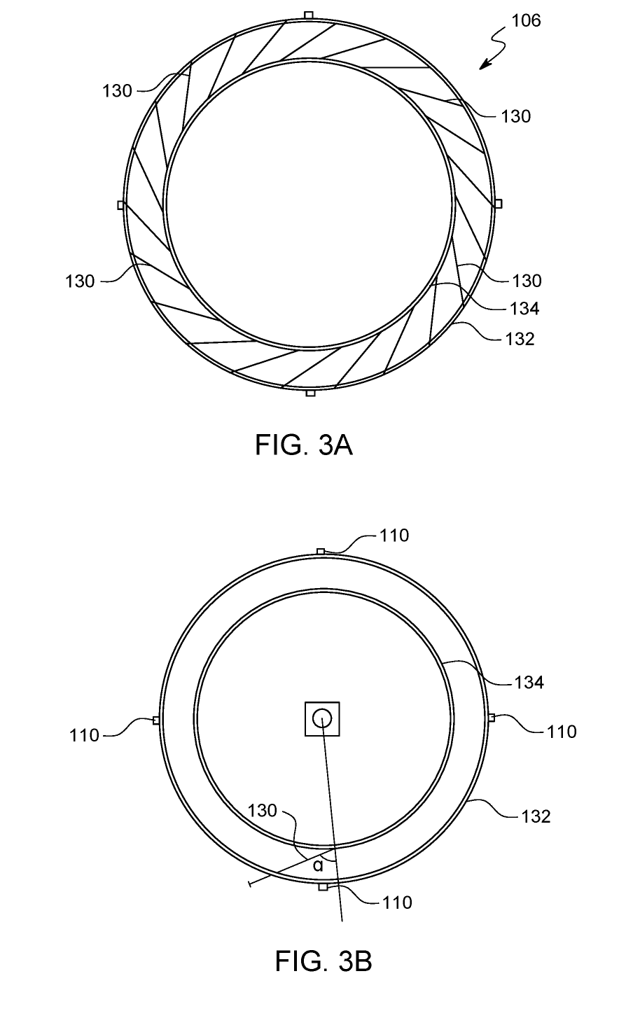

Referring to FIG. 3A, a top view of the wind directional panel sub-assembly 106 is illustrated. The wind directional panel sub-assembly 106 can include, but is not limited to, a plurality of wind directional panels 130, one or more outer support rings 132, and one or more inner support ring 134. The support rings 132, 134 can form a panel support structure that can be coupled to the main support structure 104.

Typically, the wind directional panels can be spaced radially about the plurality of turbine blades. Of note, adjacent wind directional panels can form a plurality of wind tunnels directing wind towards the plurality of turbine blades. As shown, the plurality of wind directional panels can be coupled to an outer support ring of the panel support structure that is in turn supported by a plurality of support members of the main support structure. By implementing the outer support ring coupled to support members, the wind directional panels do not have to provide structural support to the VAWT assembly, thus reducing an overall weight of the VAWT assembly. The support members can typically be equally spaced about the outer ring and can be placed in cement footings. The wind directional panels can further be coupled to an inner support ring of the panel support structure. Typically, the wind directional panels can be angled approximately 68 degrees from parallel with a radial line of the circle formed by the VAWT assembly. The wind directional panels can be angled between 60.1 degrees to 80 degrees.

In one embodiment, the panel support structure can include an upper outer support ring, a lower outer support ring, an upper inner support ring, and a lower inner support ring. The outer support rings 132 can be coupled to the plurality of support members 110 of the main support structure 102. An upper portion of an exterior end of the wind directional panels 130 can be coupled to the upper outer support ring and a lower portion of the exterior end of the wind directional panels 130 can be coupled to the lower outer support ring. An upper portion of an interior end of the wind directional panels 130 can be coupled to the upper inner support ring and a lower portion of the interior end of the wind directional panels 130 can be coupled to the lower inner support ring. Stated alternatively, the plurality of wind directional panels 130 can be coupled to the outer support rings 132 proximate a top and a bottom of a first side of the panels 130 and can be coupled to inner support rings 134 proximate a top and a bottom of a second side of the panels 130.

Referring to FIG. 3B, a top view of the inner support ring 134, the outer support ring 132, and a wind directional panel 130 are illustrated. Of note, as shown in the top view, the wind directional panel 130 can be oriented at an angle α defined by a radial line of the substantially concentric support rings 132, 134 and the wind directional panel 130. In one example, the angle α can be approximately 68 degrees. Typically, a diameter of the outer support ring 132 can be approximately 27% larger than a diameter of the blade support ring 126. Of note, a gap between the interior support ring 134 of the plurality of wind directional panels 130 and the plurality of turbine blades 120 can be approximately 1 and ⅜ inches. As previously mentioned, an angle between a wind directional panel 130 and a radial line of a center of the VAWT assembly 100 can be approximately 68 degrees. Each of the wind directional panels can be approximately 3.5 feet wide.

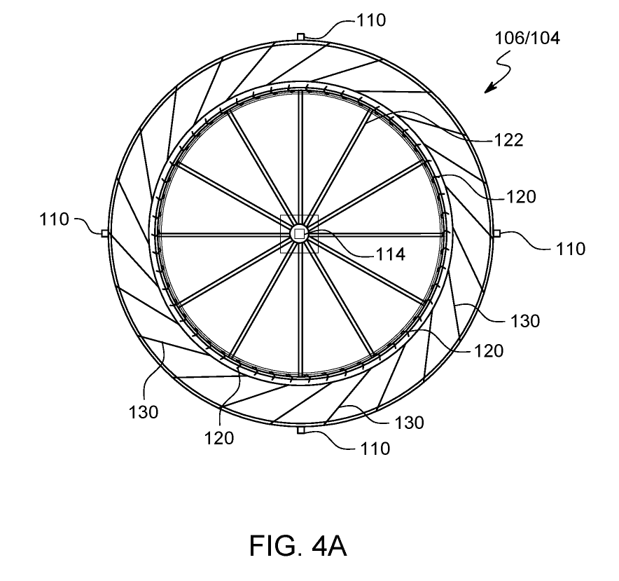

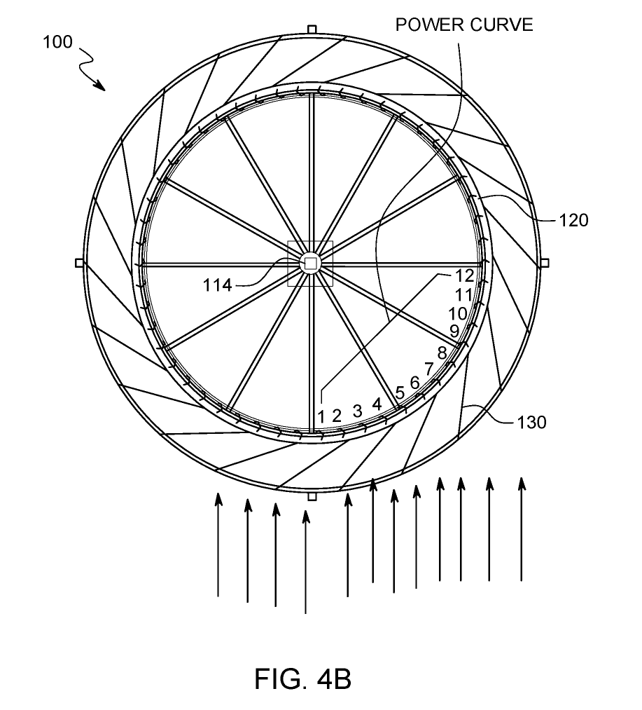

Referring to FIG. 4A, a top view of the turbine blade sub-assembly 104 and the wind directional panel sub-assembly 106 is illustrated. Of note, several components of each sub-assembly 104, 106 are illustrated.

Referring to FIG. 4B, a top view of the VAWT assembly 100 showing an example power curve formed by the plurality of wind directional panels 130 of the VAWT assembly 100 is illustrated. A wind direction, as shown, provides at least 12 turbine blades 120 in the power curve. With the wind directional panels 130 angled at approximately 68 degrees, backpressure can be reduced from wind that interfaces with the turbine blades 120. As can be appreciated, when wind blows from any direction the wind can blow to a left side, a center, and a right side of the turbine blades 120. Of note, if the wind directional panels 130 were not present, only the turbine blades marked 7-11 would make power. By having the wind directional panels angled approximately 68 degrees, the turbine blades marked 1-12 can be included in the power curve which generates power. Further, by reducing backpressure, the efficiency of the VAWT assembly 100 can be increased.

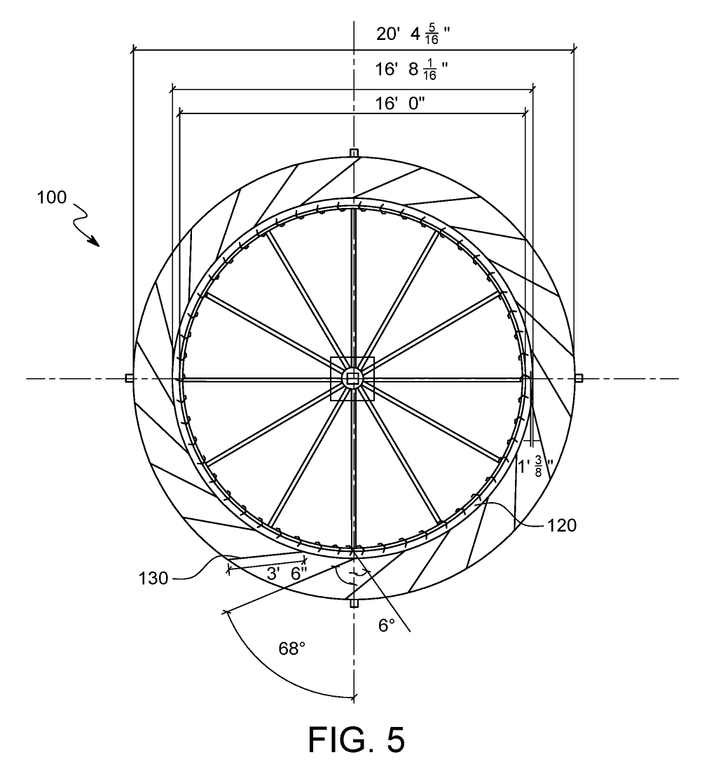

Referring to FIG. 5, a top view of the VAWT assembly 100 including example measurements is illustrated. As shown, in one example embodiment, the blade support ring 124 can have a diameter of approximately 16 feet. The outer support ring 132 of the wind directional panels 130 can have a diameter of approximately 20 feet 4 and 5/16 inches. The inner support ring 134 of the wind directional panels 130 can have a diameter of approximately 16 feet 8 and 1/16 inches. Typically, a diameter of the outer support ring 132 can be approximately 27% larger than a diameter of the blade support ring 124. Of note, a gap between the interior support ring 134, of the plurality of wind directional panels 130, and the plurality of turbine blades 120 can be approximately 1 and ⅜ inches. Each of the wind directional panels 130 can be approximately 3.5 feet wide.

In one embodiment, the VAWT assembly 100 can be provided as a kit. Typically, the kit can include a main support structure, a blade turbine sub-assembly, a wind directional panel sub-assembly, and a generator. Of note, each of the components can be substantially similar to the previously described components. In some instances, the sub-assemblies can be assembled prior to being delivered. In other instances, the sub-assemblies can be provided as individual components configured to be assembled when delivered to a site.

### Alternative Embodiments and Variations

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

I claim:

1. A vertical axis wind turbine assembly comprising:
a main support structure including two or more support members and an axle;
a turbine blade sub-assembly including:
a plurality of turbine blades;
a turbine blade support structure including a blade support ring and a plurality of blade braces, the turbine blade support structure being coupled to the plurality of turbine blades and the axle of the main support structure;
wherein each of the plurality of turbine blades are coupled to the blade support ring of the turbine blade support structure at an angle between 2 degrees to 14.9 degrees from parallel with a radial line of a circle formed by the vertical axis wind turbine assembly;
a wind directional panel sub-assembly including:
a plurality of wind directional panels, the plurality of wind directional panels spaced radially about the plurality of turbine blades;
a panel support structure including an outer support ring and an inner support ring, the panel support structure being coupled to the plurality of wind directional panels and the two or more support members of the main support structure;
wherein each of the plurality of wind directional panels are angled between 60.1 degrees to 80 degrees from parallel with a radial line of the circle formed by the vertical axis wind turbine assembly.

2. The vertical axis wind turbine assembly of claim 1, wherein each of the plurality of turbine blades include (i) a central portion, (ii) a first protrusion extending from a first end of the central portion at an angle of approximately 123 degrees, and (iii) a second protrusion extending from a second end of the central portion at an angle of approximately 115 degrees.

3. The vertical axis wind turbine assembly of claim 2, wherein the central portion and the second protrusion each have a length of approximately 3 inches and the first protrusion has a length of approximately 2 inches.

4. The vertical axis wind turbine assembly of claim 1, wherein the assembly further includes a permanent magnet generator operatively coupled to the axle.

5. The vertical axis wind turbine assembly of claim 1, wherein a distance between the inner support ring of the wind directional panel sub-assembly and the plurality of turbine blades is approximately 1 and ⅜ inches.

6. The vertical axis wind turbine assembly of claim 1, wherein a diameter of the outer support ring of the wind directional panel sub-assembly is approximately 27 percent larger than a diameter of the blade support ring.

7. The vertical axis wind turbine assembly of claim 1, wherein the vertical axis wind turbine assembly generates approximately 50-55 decibels of sound when operating.

8. The vertical axis wind turbine assembly of claim 1, wherein the plurality of turbine blades includes 48 turbine blades.

9. The vertical axis wind turbine assembly of claim 8, wherein the plurality of wind directional panels includes 20 wind directional panels.

10. The vertical axis wind turbine assembly of claim 9, wherein a power curve of the vertical axis wind turbine assembly includes 12 turbine blades.

11. A vertical axis wind turbine kit comprising:
a main support structure including:
a plurality of support members configured to be embedded in the ground; and
an axle;
a turbine blade sub-assembly including:
a blade support ring;
a plurality of blade braces configured to be coupled to the blade support ring and the axle; and
a plurality of turbine blades, the plurality of turbine blades configured to (i) be coupled to the blade support ring, and (ii) include (a) a central portion, (b) a first protrusion extending from a first end of the central portion forming an angle of approximately 123 degrees, and (c) a second protrusion extending from a second end of the central portion forming an angle of approximately 115 degrees;
a wind directional panel sub-assembly including:
an outer support ring configured to be coupled to the plurality of support members;
an inner support ring; and
a plurality of wind directional panels configured to be coupled between the outer support ring and the inner support ring;
a generator configured to be operatively coupled to the axle of the main support structure.

12. The vertical axis wind turbine kit of claim 11, wherein each of the plurality of turbine blades are configured to be coupled to the blade support ring at an angle between 2 degrees to 14.9 degrees from parallel with a radial line of a circle formed by the kit when assembled.

13. The vertical axis wind turbine kit of claim 11, wherein each of the plurality of wind directional panels are configured to be coupled between the outer support ring and the inner support ring at an angle between 60.1 degrees to 80 degrees from parallel with a radial line of a circle formed by the kit when assembled.

14. The vertical axis wind turbine kit of claim 11, wherein a distance between the inner support ring of the wind directional sub-assembly and the plurality of turbine blades is approximately 1 and ⅜ inches when assembled.

15. The vertical axis wind turbine kit of claim 11, wherein the generator is a permanent magnet generator.

16. The vertical axis wind turbine kit of claim 11, wherein each of the plurality of turbine blades are configured to be coupled to the blade support ring at an angle of approximately 6 degrees from parallel with a radial line of a circle formed by the vertical axis wind turbine assembly when assembled.

17. The vertical axis wind turbine kit of claim 11, wherein each of the plurality of wind directional panels are configured to be coupled between the outer support ring and the inner support ring at an angle of approximately 68 degrees from parallel with a radial line of the circle formed by the vertical axis wind turbine assembly when assembled.

18. The vertical axis wind turbine kit of claim 11, wherein the kit further includes:
at most two flange bearings; and
at most one thrust bearing.

19. The vertical axis wind turbine kit of claim 18, wherein the axle is configured to be coupled to the two flange bearings and the thrust bearing.

20. A vertical axis wind turbine assembly comprising:
a main support structure including a plurality of support members embedded in the ground and an axle;
a turbine blade sub-assembly including:
a blade support ring;
a plurality of blade braces coupled to the blade support ring and the axle; and
a plurality of turbine blades (i) coupled to the blade support ring, and (ii) including (a) a central portion, (b) a first protrusion extending from a first end of the central portion forming an angle of approximately 123 degrees, and (c) a second protrusion extending from a second end of the central portion forming an angle of approximately 115 degrees;
wherein each of the plurality of turbine blades are coupled to the blade support ring at an angle of approximately 6 degrees from parallel with a radial line of a circle formed by the vertical axis wind turbine assembly;
a wind directional panel sub-assembly including:
an outer support ring coupled to the plurality of support members;
an inner support ring; and
a plurality of wind directional panels coupled between the outer support ring and the inner support ring;
wherein each of the plurality of wind directional panels are coupled between the outer support ring and the inner support ring at an angle of approximately 68 degrees from parallel with a radial line of the circle formed by the vertical axis wind turbine assembly;
a generator operatively coupled to the axle of the main support structure.
